(19) United States
(12) Patent Application Publication
(10) Pub. No.: US 2025/0063422 A1
(43) Pub. Date: Feb. 20, 2025

(54) Electronic Device with Modem Having Parameterized Balanced Data Rate

(71) Applicant: Apple Inc., Cupertino, CA (US)

(72) Inventors: Thorsten Clevorn, Munich (DE); Stefan Meyer, Hoechstadt (DE); Norman Goris, Dortmund (DE)

(21) Appl. No.: 18/764,023

(22) Filed: Jul. 3, 2024

Related U.S. Application Data
(60) Provisional application No. 63/519,713, filed on Aug. 15, 2023.

(51) Int. Cl. H04W 28/02; H04L 1/1812; H04L 1/1829

(52) U.S. Cl. CPC H04W 28/0268; H04L 1/1812; H04L 1/1835; H04L 1/1854

(57) ABSTRACT

A communications system may include a user equipment (UE) device that communicates with a wireless network. The UE device may transmit a signal to the wireless network identifying a peak data rate of a modem on the UE device, a balanced data rate of the modem, and a buffer size of the modem. The UE device may receive downlink data from the wireless network and may store the downlink data at buffer circuitry on the modem. The UE device may perform delayed processing of the downlink data across slots in a manner that allows for a reduction in size of the modem.

This application claims the benefit of U.S. Provisional Patent Application No. 63/519,713, filed Aug. 15, 2023, which is hereby incorporated by reference herein in its entirety.

### FIELD

This disclosure relates generally to wireless communications, including wireless communications performed by user equipment devices.

### BACKGROUND

Communications systems can include a user equipment device that conveys wireless data with a cellular network. The user equipment device includes a modem that processes wireless data that is transmitted and received by the user equipment device. If care is not taken, the modem can consume excessive resources such as power in the user equipment device or can exhibit insufficient levels of performance.

### SUMMARY

A wireless communications system, a wireless network, and/or a user equipment device that perform wireless communications as set forth herein are provided.

### BRIEF DESCRIPTION OF THE DRAWINGS

FIG. 1 is a diagram of an illustrative communications system having a user equipment device that communicates with a wireless network in accordance with some embodiments.

FIG. 2 is a schematic block diagram of an illustrative user equipment device in accordance with some embodiments.

FIG. 3 is a diagram of an illustrative modem having a primary buffer and an extended buffer for storing and processing downlink data in accordance with some embodiments.

FIG. 4 is a diagram showing how an illustrative user equipment device may transmit a balanced data rate, a peak data rate, and a buffer size to a wireless network in accordance with some embodiments.

FIG. 5 is a flow chart of illustrative operations involved in performing wireless communications using a user equipment device having a modem that includes a primary buffer and an extended buffer for storing and processing downlink data in accordance with some embodiments.

FIG. 6 is a diagram showing how different slots of downlink data may be transmitted to a user equipment device and stored on a primary buffer and an extended buffer over time in accordance with some embodiments.

FIG. 7 is a diagram showing how portions of slots of downlink data may be stored on an illustrative extended buffer and may be processed and cleared in a delayed manner in accordance with some embodiments.

FIG. 8 is a diagram showing how an illustrative modem may clear an extended buffer after the extended buffer has been filled with downlink data in accordance with some embodiments.

FIG. 9 is a diagram showing how an illustrative modem may perform HARQ handling for a balanced data rate in accordance with some embodiments.

FIG. 10 is a diagram showing how an illustrative modem may perform HARQ handling with additional peak data rate processing delay in accordance with some embodiments.

FIG. 11 is a diagram showing how an illustrative modem may concurrently receive downlink data over multiple carriers in accordance with some embodiments.

FIG. 12 is a diagram showing how an illustrative modem may process stored downlink data from different carriers in accordance with some embodiments.

### DETAILED DESCRIPTION

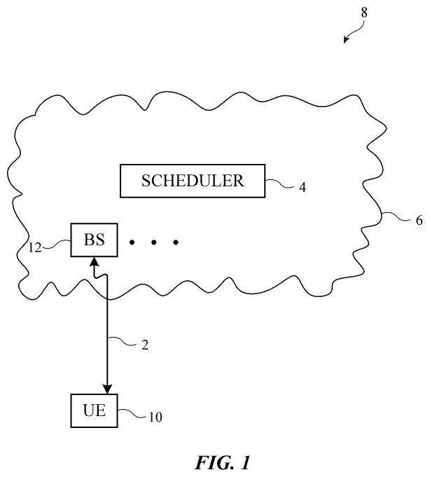

FIG. 1 is a diagram of an illustrative communications system 8. Communications system 8 (sometimes referred to herein as communications network 8, network 8, or system 8) includes a user equipment (UE) device 10 that communicates with a wireless network such as wireless network 6 (e.g., a cellular telephone network, a wireless local area network, or another type of wireless communications network). Communications system 8 may also include a core network (not shown) coupled to wireless network 6 over one or more wired and/or wireless links.

In general, wireless network 6 and the core network may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of wireless network 6 and/or the core network may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of wireless network 6 and/or the core network may include network switches, network routers, optical add-drop multiplexers, other multiplexers, repeaters, modems, portals, gateways, communications satellites, servers, network cards (line cards), wireless access points, wireless base stations, and/or any other desired network components. The network nodes in wireless network 6 and/or the core network may include physical components such as electronic devices, servers, computers, network racks, line cards, user equipment, etc., and/or may include virtual components that are logically defined in software and that are distributed across (over) two or more underlying physical devices (e.g., in a cloud network configuration).

Implementations in which wireless network 6 is a cellular telephone network having one or more wireless base stations such as base station (BS) 12 are described herein as an example. In other implementations, wireless network 6 may be a wireless local area network (e.g., base station 12 may be replaced with a wireless access point) or any other desired type of wireless network (e.g., base station 12 may be replaced with any desired wireless network node or external device).

UE device 10 may wirelessly communicate with base station 12 using a wireless communications link. UE device 10 may convey radio-frequency signals 2 with base station 12 to support the wireless communications link. Radio-frequency signals 2 may be conveyed in an uplink (UL) direction from UE device 10 to base station 12 and/or in a downlink (DL) direction from base station 12 to UE device 10. If desired, UE device 10 may wirelessly communicate with base station 12 without passing communications through any other intervening network nodes in communications system 8 (e.g., UE device 10 may communicate directly with base station 12 over-the-air). If desired, UE device 10 may concurrently communicate with multiple base stations 12 of wireless network 6 (e.g., at different frequencies under a carrier aggregation (CA) scheme).

Each base station 12 in wireless network 6 may include one or more antennas (e.g., antennas arranged in one or more phased antenna arrays for conveying radio-frequency signals 16 at frequencies greater than 10 GHz or other antennas for conveying signals at lower frequencies) that provide wireless coverage for UE devices located within a corresponding geographic area or region, sometimes referred to as the coverage area, service area, or cell of the corresponding base station. In other words, each base station 12 may have a respective cell in wireless network 6 that covers a corresponding geographic area and each base station 12 may communicate with UE devices located within its cell.

Each cell of wireless network 6 may have any desired shape (e.g., a circular shape, a hexagonal shape, etc.) and may cover any desired area. In general, the size of a cell may correspond to the maximum transmit power level of its base station 12 and the over-the-air attenuation characteristics for radio-frequency signals conveyed by that base station 12. The cells of wireless network 6 may be distributed over one or more geographic regions, areas, or locations such as one or more buildings, campuses, cities, counties, provinces, states, countries, or continents.

When a UE device is located within a given cell, the UE device may connect with the base station 12 of that cell (sometimes referred to herein as attaching to base station 12) and may then communicate with the base station over a wireless link (e.g., using radio-frequency signals 2). To support the wireless link, base station 12 may transmit radio-frequency signals 2 in the DL direction, sometimes referred to herein as DL signals, and/or the UE device may transmit radio-frequency signals 2 in the UL direction, sometimes referred to herein as UL signals (e.g., the wireless link may be a bidirectional link). The DL signals may convey or carry DL data. The UL signals may convey or carry UL data.

Wireless network 6 may be operated, controlled, serviced, and/or administered by a corresponding network operator or service provider. Each UE device of wireless network 6 (e.g., UE devices registered with wireless network 6) may, for example, include a subscriber identity module (SIM) associated with wireless network 6 and/or the network operator of wireless network 6 (e.g., a cellular network carrier or service provider, sometimes also referred to as a mobile network operator (MNO)). The SIM may include a physical SIM card or an electronic SIM (eSIM). If desired, UE device 10 may store and maintain multiple SIMs (e.g., in a multi-SIM configuration). Wireless network 6, the corresponding network operator, and/or the core network may sometimes be referred to herein collectively as “the network.”

The network operator may use one or more schedulers such as scheduler 4 to generate, store, maintain, update, and/or implement one or more communications schedules for the UE devices that communicate with the base stations of wireless network 6 (e.g., UE devices 10 registered with wireless network 6). The communications schedule identifies the communications resources (e.g., frequency resources, timing resources, radio access technology (RAT) resources, data modulation/encoding resources, etc.) used to convey wireless data to and/or from each of the UE devices of wireless network 6 (e.g., in a manner that balances traffic loads across the resources of wireless network 6 while minimizing interference between the UE devices). The communications schedule may be stored on storage circuitry on one or more base stations 12 and/or other nodes of wireless network 6 that are communicatively coupled to base station 12. Scheduler 4 may be implemented/executed using one or more processors located on one or more base stations 12, on one or more other nodes of wireless network 6, and/or may be distributed across two or more nodes of wireless network 6 (e.g., base stations 12 and/or other devices in wireless network 6).

UE device 10 may convey wireless data with another node of communications system 8 via base station 12. For example, UE device 10 may transmit wireless data (e.g., UL data) to base station 12 (using radio-frequency signals 2) for forwarding to an end host of wireless network 6 and/or the core network (e.g., a given host of the core network and/or another UE device). Additionally or alternatively, base station 12 may receive wireless data from an end host of wireless network 22 and/or the core network (e.g., a given host of the core network and/or another UE device) for forwarding to UE device 10 (e.g., as DL data in radio-frequency signals 2).

The end host may, for example, include one or more servers of a content delivery network (CDN) that serves wireless content (e.g., application data, streaming audio data, streaming video data, email messages, text messages, notifications, emergency messages, internet data, image data, operating system data, etc.) to UE device 10 via wireless network 6. Additionally or alternatively, the host may include one or more message or data forwarding servers (e.g., of a corresponding cloud region, in the core network, etc.) that relay or forward wireless data between UE device 10 and another UE device. In general, the host may be any desired source and/or destination of wireless data conveyed by UE device 10.

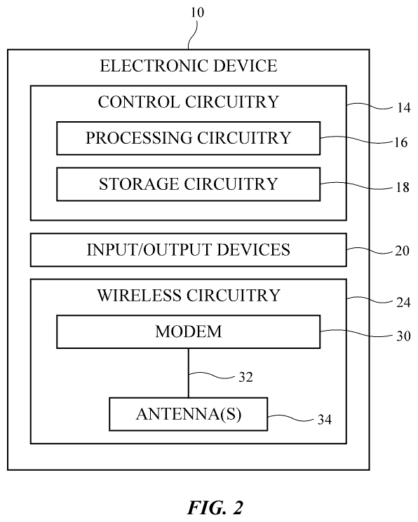

FIG. 2 is a block diagram of UE device 10 (sometimes rereferred to herein as electronic device 10 or simply as device 10). Device 10 may be a computing device such as a laptop computer, a desktop computer, a computer monitor containing an embedded computer, a tablet computer, a cellular telephone (mobile phone), a media player, or other handheld or portable electronic device, a smaller device such as a wristwatch device, a pendant device, a headphone or earpiece device, a device embedded in eyeglasses or other equipment worn on a user's head (e.g., virtual reality, augmented reality, mixed reality, and/or extended reality glasses, goggles, or head-mounted display devices), or another wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in FIG. 2, device 10 may include components located on or within an electronic device housing. The housing, which is sometimes also referred to as a case, may be formed of plastic, glass, ceramics, fiber composites, metal (e.g., stainless steel, aluminum, metal alloys, etc.), other suitable materials, or a combination of these materials. In some situations, part or all of the housing may be formed from dielectric or other low-conductivity material (e.g., glass, ceramic, plastic, sapphire, etc.). In other situations, the housing or at least some of the structures that make up the housing may be formed from metal elements.

Device 10 may include control circuitry 14. Control circuitry 14 may include storage such as storage circuitry 18. Storage circuitry 18 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 18 may include storage that is integrated within device 10 and/or removable storage media.

Control circuitry 14 may include processing circuitry such as processing circuitry 16. Processing circuitry 16 may be used to control the operation of device 10. Processing circuitry 16 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 18 (e.g., storage circuitry 18 may include non-transitory (tangible) computer readable storage media that stores the software code). The software code may sometimes be referred to as program instructions, software, data, instructions, or code. Software code stored on storage circuitry 18 may be executed by processing circuitry 16.

Control circuitry 14 may be used to run software on device 10 such as one or more software applications (apps). The applications may include satellite navigation applications, internet browsing applications, voice-over-internet-protocol (VOIP) telephone call applications, email applications, media playback applications, operating system functions, gaming applications, productivity applications, workplace applications, augmented reality (AR) applications, extended reality (XR) applications, virtual reality (VR) applications, scheduling applications, consumer applications, social media applications, educational applications, banking applications, spatial ranging applications, sensing applications, security applications, media applications, streaming applications, automotive applications, video editing applications, image editing applications, rendering applications, simulation applications, camera-based applications, imaging applications, news applications, and/or any other desired software applications.

To support interactions with external communications equipment, control circuitry 14 may be used in implementing communications protocols. Communications protocols that may be implemented using control circuitry 14 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), satellite communications protocols, and/or any other desired communications protocols. Each communications protocol may be associated with a corresponding radio access technology (RAT) that specifies the physical connection methodology used in implementing the protocol. Radio-frequency signals conveyed using a cellular telephone protocol may sometimes be referred to herein as cellular telephone signals.

Device 10 may include input-output devices 20. Input-output (I/O) devices 20 may be used to allow data to be supplied to device 10 and to allow data to be provided from device 10 to external devices. Input-output devices 20 may include user interface devices, data port devices, and other input-output components. For example, input-output devices 20 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, image sensors, light sensors, radar sensors, lidar sensors, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 20 may be peripherals that are coupled to a main processing unit or other portion of device 10 via a wired or wireless link).

Device 10 may include wireless circuitry 24. Wireless circuitry 24 may support wireless communications. Wireless circuitry 24 (sometimes referred to herein as wireless communications circuitry 24) may include one or more antennas 34. Antennas 34 may transmit radio-frequency signals to and/or may receive radio-frequency signals from external communications equipment. The external communications equipment may include one or more other electronic devices such as device 10, a wireless base station, or a wireless access point, as examples.

Wireless circuitry 24 may also include one or more modems 30. Modem 30 (sometimes also referred to herein as a radio) may include radio-frequency circuitry and baseband circuitry. Modem 30 may be, for example, a cellular modem that communicates with wireless network 6 of FIG. 1. The baseband circuitry may include one or more baseband processors or other circuitry that operates at baseband. The radio-frequency circuitry may include transceiver circuitry coupled to the baseband circuitry over one or more baseband paths. The one or more baseband paths may be implemented as a digital interface (e.g., having digital signal lines that convey digital data bits). The transceiver circuitry may include one or more transmitters and one or more receivers. The receiver(s) and transmitter(s) may be integrated into one or more transceivers if desired.

The radio-frequency circuitry in modem 30 may be coupled to one or more antennas 34 over one or more radio-frequency transmission lines 32. Radio-frequency transmission lines 32 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines 32 may be integrated into rigid and/or flexible printed circuit boards if desired. One or more radio-frequency lines 32 may be shared between multiple transceivers in transceiver circuitry 30 if desired. Radio-frequency front end (RFFE) modules may be interposed on one or more radio-frequency transmission lines 32. The radio-frequency front end modules may include substrates, integrated circuits, chips, or packages that are separate from transceiver circuitry 30 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines 32.

In performing wireless transmission, the baseband circuitry in modem 30 may provide baseband signals (e.g., digital signals containing wireless data for transmission to one or more other devices) to the transceiver circuitry (e.g., one or more transmitters) in modem 30 over the digital interface. For example, the baseband circuitry may process incoming digital data through encoding, modulation/demodulation, time and frequency conversions, pulse shaping, etc., to generate processed baseband data that is conveyed by the baseband signals. The transceiver circuitry in modem 30 may modulate the processed baseband data onto radio-frequency signals for transmission by antenna(s) 34. For example, the transceiver circuitry may include mixer circuitry and local oscillator circuitry for up-converting the baseband signals to radio frequencies prior to transmission over antenna(s) 34. The transceiver circuitry may also include digital-to-analog converter (DAC) circuitry for converting signals between digital and analog domains, amplifier circuitry (e.g., power amplifier circuitry) for amplifying the radio-frequency signals, filter circuitry, switching circuitry, etc. The transceiver circuitry may transmit the radio-frequency signals over antenna(s) 34 via radio-frequency transmission line path(s) 32. Antenna(s) 34 may transmit the radio-frequency signals to external wireless equipment by radiating the radio-frequency signals into free space.

Antenna(s) 34 may be formed using any desired antenna structures for conveying radio-frequency signals. For example, antenna(s) 34 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 34 over time. If desired, two or more of antennas 34 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction (e.g., towards external communications equipment).

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 34 may transmit the radio-frequency signals by radiating the radio-frequency signals into free space (or to free space through intervening device structures such as a dielectric cover layer). Antenna(s) 34 may additionally or alternatively receive the radio-frequency signals from free space (e.g., through intervening devices structures such as a dielectric cover layer). The transmission and reception of radio-frequency signals by antennas 34 each involve the excitation or resonance of antenna currents on an antenna resonating element in the antenna by the radio-frequency signals within the frequency band(s) of operation of the antenna.

In performing wireless reception, antenna(s) 34 may receive radio-frequency signals from one or more other devices. Antenna(s) 34 may pass the received radio-frequency signals to transceiver circuitry (e.g., one or more receivers) in modem 30 over radio-frequency transmission line(s) 32. The transceiver circuitry may include demodulation circuitry, mixer circuitry for down-converting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 34. The transceiver circuitry in modem 30 may convert the received radio-frequency signals into baseband signals (e.g., digital data samples). The transceiver circuitry may transmit the baseband signals to the baseband circuitry in modem 30 over the digital interface. The baseband circuitry may process the incoming digital data from the received baseband signals through decoding, demodulation, time and frequency conversions, pulse shaping, etc., to extract wireless data from the baseband signals. The extracted wireless data may be passed up the protocol stack or to an application processor for further processing.

The transceiver circuitry in modem 30 may transmit and/or receive radio-frequency signals within corresponding frequency bands at radio frequencies (sometimes referred to herein as communications bands or simply as “bands”). The frequency bands handled by modem 30 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHZ WLAN band (e.g., from 2400 to 2480 MHZ), a 5 GHZ WLAN band (e.g., from 5180 to 5825 MHZ), a Wi-Fi® 6E band (e.g., from 5925-7125 MHZ), and/or other Wi-Fi® bands (e.g., from 1875-5160 MHz), wireless personal area network (WPAN) frequency bands such as the 2.4 GHZ Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHZ, 6G bands such as sub-THz bands between around 100 GHz and around 10 THz, etc.), other centimeter or millimeter wave frequency bands between 10-300 GHz, near-field communications (NFC) frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest. Wireless circuitry 24 may also be used to perform spatial ranging operations if desired.

The example of FIG. 1 is illustrative and non-limiting. While control circuitry 14 is shown separately from wireless circuitry 24 in the example of FIG. 1 for the sake of clarity, wireless circuitry 24 may include processing circuitry (e.g., one or more processors) that forms a part of processing circuitry 16 and/or storage circuitry that forms a part of storage circuitry 18 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of transceiver circuitry 30. The baseband circuitry may, for example, access a communication protocol stack on control circuitry 14 (e.g., storage circuitry 18) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer.

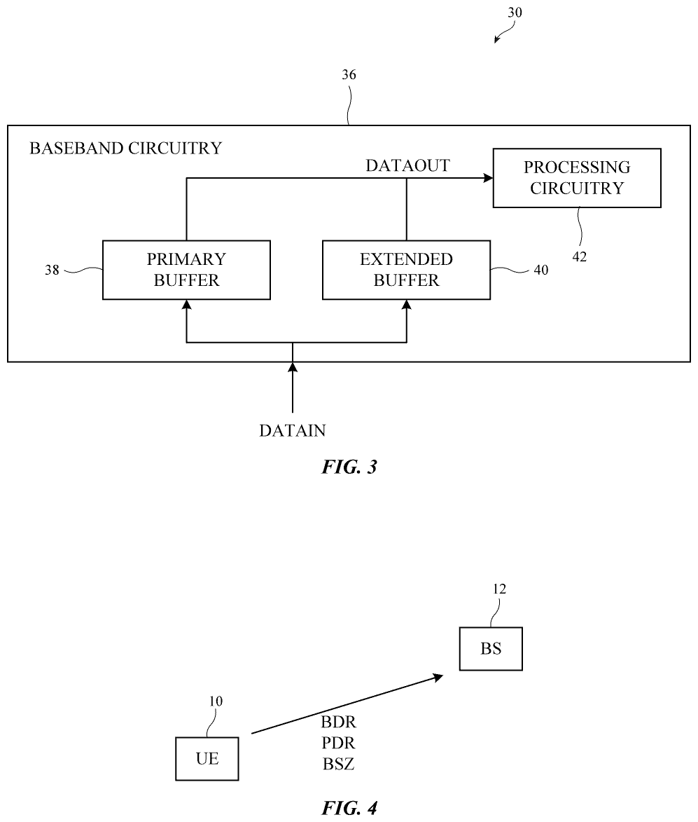

FIG. 3 is a diagram of modem 30. As shown in FIG. 3, modem 30 may include baseband circuitry 36. Baseband circuitry 36 may include buffer circuitry such as at least a primary buffer 38 (sometimes referred to herein as first buffer 38, default buffer 38, first portion 38 of buffer circuitry on modem 30, or a first portion of a buffer on modem 30) and an extended buffer 40 (sometimes referred to herein as second buffer 40, extended buffer 40, second portion 40 of buffer circuitry on modem 30, or second portion 40 of a buffer on modem 30). Baseband circuitry 36 may also include processing circuitry 42 (e.g., some or all of one or more processors from processing circuitry 16 of FIG. 2, a digital signal processor, one or more logic gates, etc.). During DL signal reception, modem 30 receives DL signals from base station 12 in radio-frequency signals 2 of FIG. 1. A receiver in modem 30 (not shown) downconverts the DL signals into (digital) DL data DATAIN provided to baseband circuitry 36. Interface circuitry of baseband circuitry 36 stores DL data DATAIN in primary buffer 38 as the DL data is received. When the DL data is received at an excessive data rate (e.g., a peak data rate of baseband circuitry 36), the interface circuitry stores excess or overflow DL data in extended buffer 40. Processing circuitry 42 receives (e.g., reads) the DL data stored in primary buffer 38 and extended buffer 40 (as output data DATAOUT) and processes the DL data. As the data is read out from the buffer(s) and processed, the space occupied on the buffer(s) by the read out data is cleared to make room for storage of additional DL data DATAIN as the additional DL data is received. Processing circuitry 42 may perform any desired processing operations on output data DATAOUT (e.g., any desired digital signal processing, fast Fourier transforms (FFTs), rotations, conversions, etc.). Processing circuitry 42 may pass the processed data up the protocol stack (e.g., to an application layer for further processing by an application processor on device 10).

In practice, many modems are designed to handle peak data-rates, although these data-rates typically do not occur and also cannot be maintained for a long time period. This can generate an excessive a hardware (HW), area, and power overhead, because only a fraction of the HW is used by the modem most of the time. For example, a given modem may only utilize around 10 to 20% of its peak performance capability while handling most real-time use-cases.

One solution to reduce the area and power overhead of modem 30 is to define a reduced, average, or balanced data rate (sometimes referred to herein as balanced data rate BDR, an average data rate, a reduced data rate, or a long term data rate) that is less than the peak data rate of modem 30 (sometimes referred to herein as peak data rate PDR). Modem 30 may store and process DL data at its balanced data rate at all times. On the other hand, modem 30 may store and process DL data at its peak data rate for only a short amount of time. The peak data rate is handled via buffering and distributing the load of a single slot over several slots. This approach ensures that the HW is not over dimensioned and still guarantees the NW scheduling flexibility.

Processing of DL data by modem 30 is described herein for the sake of illustration (e.g., because UL data processing only consumes a fraction of the UE power and area consumed by DL data processing). Furthermore, only physical downlink shared channel (PDSCH) processing is described herein for the sake of simplicity, whereas physical downlink control channel (PDCCH) processing is kept in-line with the peak performance and maximum number of carriers of modem 30 (e.g., because the HW resources for PDCCH handling are much smaller than the associated PDSCH resources and thus no further reduction is required for PDCCH handling).

Device 10 may define three basic parameters used to define the capabilities of modem 30 with respect to peak data rate verses balanced data rate. First, UE device 10 may define the balanced data rate BDR of modem 30 (e.g., in units of resource elements (RE) per unit time such as per transmission time interval (TTI)). The balanced data rate BDR of modem 30 represents the baseline processing capability of modem 30. Modem 30 may store DL data in primary buffer 38 and may process the DL data stored on primary buffer 38 at data rates up to balanced data rate BDR without having to perform any additional buffering or processing delay. Processing circuitry 42 may be designed to constantly cope with balanced data rate BDR rate. As such, balanced data rate BDR effectively defines the minimum size of modem 30. For example, about 20% of the capabilities of modem 30 may be sufficient to handle all of real life DL data processing scenarios with only a minimal impact in very rare cases where the peak throughput is actually used and achieved. This may form a starting point for comparing the balanced data rate to the currently supported peak data rate of modem 30. Note that balanced data rate BDR is defined for a certain unit of time (e.g. one TTI, 1 ms, etc.). In case of carriers with different slot durations, the capabilities of modem 30 may be scaled accordingly (e.g., 20 RE/ms==10 RE/0.5 ms, etc.). When checking whether balanced data rate BDR is met while receiving DL data or superseded for several carriers, the sum of all overlapping slots and associated RE's may be calculated and checked.

Second, UE device 10 may define the peak data rate PDR of modem 30 (e.g., in units of resource elements (RE) per unit time such as per transmission time interval (TTI)). The peak data rate PDR represents the maximum capability of modem 30, which is higher than balanced data rate BDR and can be supported for a short duration. [symbol] As the modem processing envelope is designed for balanced data rate BDR, the higher peak data rate requires additional buffering and offline post processing (e.g., using extended buffer 40). It is assumed herein that the time or frequency domain samples of DL data are stored (e.g. pre or post FFT) in the buffer(s). The offline post-processing induces a certain delay when handling the DL data and creating the associated ACK/NACK response for transmission (in the UL direction) to BS 12 (FIG. 1).

[symbol]

Third, UE device 10 may define the buffer size (BSZ) of modem 30 (e.g., in units of resource elements (RE)). Buffer size BSZ may represent the sum of the buffer size of primary buffer 38 and the buffer size of extended buffer 40. Extended buffer 40 is filled when DL data is received at a DL data rate exceeding balanced data rate BDR and is released when a slot or symbol of the stored data has been processed by processing circuitry 42, over several slots. Buffer size BSZ effectively defines the duration that the NW can send DL data to UE device 10 at peak data rate PDR, until the DL data rate has to be throttled to balanced data rate BDR or lower, so as not to exceed the buffer capacity of modem 30. UE device 10 may transmit all three of these parameters to base station 12 so all three parameters are known to the NW. As such, these operations are also feasible in multi-carrier scenarios. Buffer size BSZ together with peak data rate PDR and balanced data rate BDR also define the maximum delay for a given slot that can be accumulated at modem 30.

These three parameters are not including the raw data rate at the output of the decoder (e.g., processing circuitry 42), but are instead in the RE/time domain. The latter is relevant for most of the processing blocks of processing circuitry 42 (e.g., Channel Estimator blocks, Demodulator blocks, Decoder blocks, time-domain handling blocks, etc.) and thus for most of the overall physical layer area and dimensioning of modem 30. The DL hard bits are correlated to the RE/time domain together with the used modulation scheme/code-rate and mainly affect Layer 2 (L2) processing and AP-BB interface handling for modem 30. The data rate and associated parameters are dependent on the sub-carrier spacings as well as the carrier frequency, as not all combinations are allowed, and thus cannot be used as generally as RE/time.

UE device 10 may transmit information identifying the balanced data rate BDR (sometimes also referred to herein as the sustained or sustainable data rate BDR of modem 30), peak data rate PDR, and buffer size BSZ of modem 30 to base station 12, as shown in FIG. 4. UE device 10 may transmit information identifying balanced data rate BDR, peak data rate PDR, and buffer size BSZ using one or more data payload or header bits in any desired UL message or signal. As one example, UE device 10 may use radio resource control (RRC) signaling to transmit balanced data rate BDR, peak data rate PDR, and buffer size BSZ of modem 30 to base station 12. UE device 10 may proactively or autonomously transmit balanced data rate BDR, peak data rate PDR, and buffer size BSZ of modem 30 to base station 12 (e.g., upon connection/registration with wireless network 6, periodically, or in response to any desired trigger condition) or, if desired, BS 12 may transmit a request to UE device 10 and UE device 10 may respond to the request by transmitting balanced data rate BDR, peak data rate PDR, and buffer size BSZ of modem 30 to base station 12.

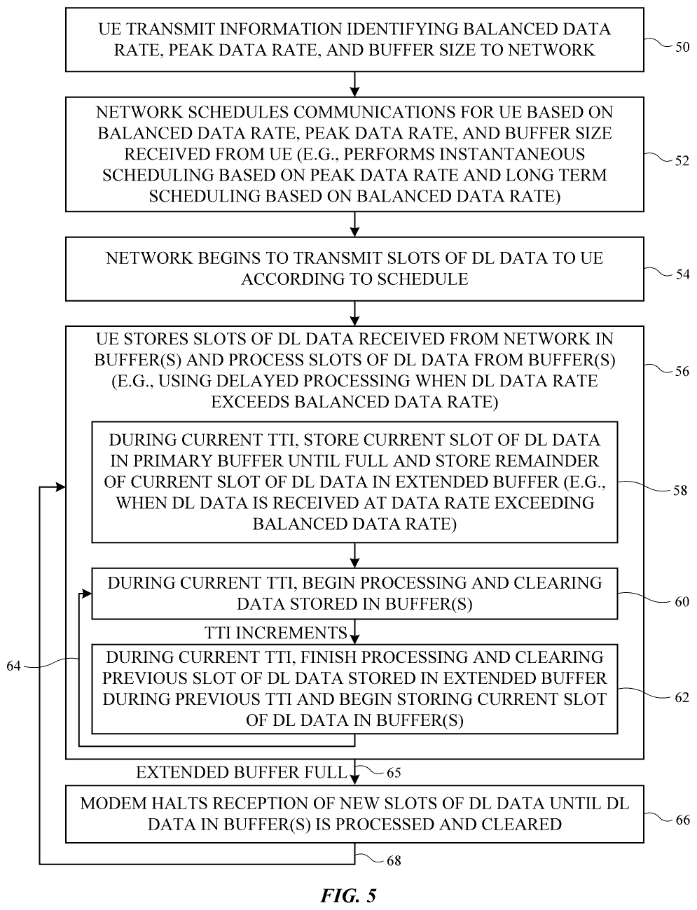

FIG. 5 is a flow chart of illustrative operations involved in performing wireless communications between UE device 10 and base station 12. At operation 50, UE device 10 may transmit balanced data rate BDR, peak data rate PDR, and buffer size BSZ of modem 30 to base station 12 (or any desired signal or information identifying balanced data rate BDR, peak data rate PDR, and buffer size BSZ of modem 30). Additionally or alternatively, UE device 10 may transmit information identifying a guaranteed bit rate or capability of UE device 10 to the network (e.g., a third UE device or bit/data rate capability in addition to the peak and balanced data rates).

At operation 52, the network may schedule communications for UE device 10 based on the balanced data rate BDR, peak data rate PDR, and buffer size BSZ received from UE device 10 (e.g., may generate or update a communications schedule for UE device 10 using scheduler 4 of FIG. 1). If desired, the network may generate the communications schedule in a manner that helps to ensure that modem 30 does not fill extended buffer 40. For example, the network may perform instantaneous scheduling (e.g., scheduling for the next TTI or some set of TTIs within a fixed duration from the present) based on peak data rate PDR (e.g., to ensure that DL data transmitted at a DL data rate exceeding balanced data rate BDR can be handled by modem 30) and/or may perform long term scheduling based on balanced data rate BDR.

At operation 54, base station 12 may begin to transmit slots of DL data to UE device 10 according to the communication schedule. Base station 12 may continue to transmit DL data according to the schedule while processing the remaining operations of FIG. 5 if desired.

At operation 56, UE device 10 may begin to receive the slots of DL data transmitted by base station 12. Modem 30 may pass the DL data (as input data DATAIN) to baseband circuitry 36 (FIG. 3). Baseband circuitry 36 may store the DL data on primary buffer 38 and/or extended buffer 40 (e.g., if the DL data rate of the DL data exceeds balanced data rate BDR, UE device 10 may store the excess DL data received per unit time that does not otherwise fit on primary buffer 38 on extended buffer 40). Processing circuitry 42 may process the DL data stored on primary buffer 38 and/or extended buffer 40 (e.g., using processing that is delayed by at least one slot when the DL data rate exceeds balanced data rate BDR).

For example, at operation 58, during a current time period (e.g., a current TTI), UE device 10 receives a current slot of DL data from base station 12 (e.g., as transmitted according to the communication schedule). Baseband circuitry 36 may store the current slot of DL data received from base station 12 in primary buffer 38 until primary buffer 38 is full. If or when the DL data rate of the current slot of DL data exceeds balanced data rate BDR, baseband circuitry 36 may store the remainder of the current slot of DL data received from base station 12 in extended buffer 40.

At operation 60, during the current time period (e.g., the current TTI), processing circuitry 42 may begin processing and clearing the DL data stored in primary buffer 38 and/or extended buffer 40. When the DL data rate of the current slot of DL data is less than or equal to balanced data rate BDR, processing circuitry 42 may process and clear the DL data from primary buffer 38 as fast as the DL data is received (e.g., processing circuitry 42 may perform online process of the DL data). When the DL data rate of the current slot of DL data exceeds balanced data rate BDR, processing circuitry 42 may begin to process and clear the current slot of DL data from extended buffer 40 during the current time period if possible. When the current time period elapses (e.g., when the TTI increments such that the next TTI becomes the current TTI), processing proceeds to operation 62.

At operation 62, during the current (now-incremented) TTI (e.g., a subsequent time period to the timer period of operations 58-60, which is now the current time period), processing circuitry 42 may finish processing and clearing the previous slot of DL data from extended buffer 40. As the DL data is cleared from extended buffer 40, baseband circuitry 36 may store the current slot of DL data received from base station 12 (e.g., the slot subsequent to the slot received while processing operation 58) on primary buffer 38 and, if needed, on extended buffer 40. Processing may then loop back to operation 60 via path 64 as additional time periods (TTI's) elapse and additional slots of DL data are received, stored, processed, and cleared.

In the event that extended buffer 40 becomes full, processing may proceed from operation 56 to operation 66 via path 65. At operation 66, modem 30 may halt or stop reception of new slots of DL data while processing circuitry 42 continues to process and clear DL data stored on extended buffer 40 and/or primary buffer 38. Processing may then loop back to operation 56 via path 68 and modem 30 may continue to receive slots of DL data.

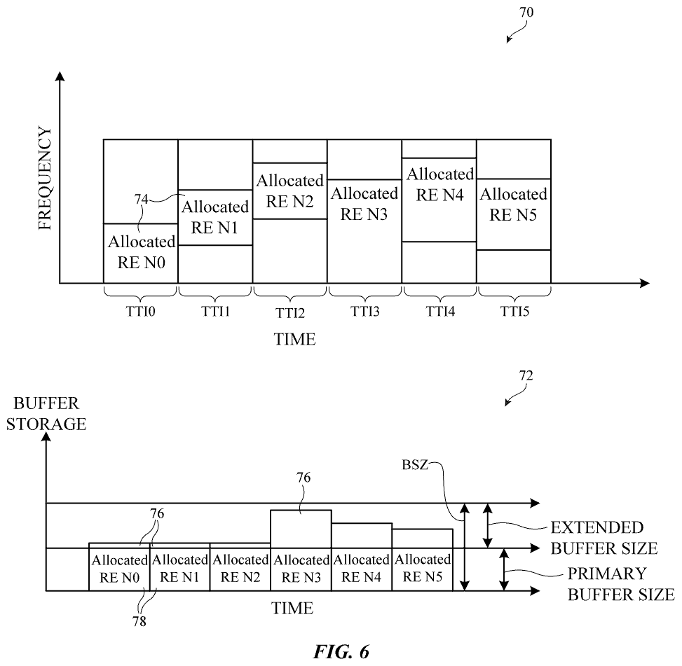

To further demonstrate the above concept, an example of a single carrier is shown in FIG. 6. Plot 70 of FIG. 6 shows exemplary slots of DL data received by UE device 10 (e.g., as allocated to UE device 10 by the network) in units of frequency as a function of time. Plot 72 of FIG. 6 shows how the slots of DL data are stored on primary buffer 38 and extended buffer 40 at the corresponding times shown in plot 70. The buffer size BSZ reported by UE device 10 to the network is given by the sum of the size of primary buffer 38 and the size of extended buffer 40.

As shown by blocks 74 in plot 70, different slots of DL data (e.g., a first set of resource elements N0, a second set of resource elements N1, etc.) are received in sequential TTI's (e.g., from TTI1 to TTI6). As shown in plot 72, each slot of DL data may be stored on primary buffer 38 until the primary buffer size is full (blocks 78), in which case the excess of each slot of DL data is stored on extended buffer 40 (blocks 76). Note that larger DL data allocations (e.g., the set of resource elements N3) will fill more of extended buffer 40 than smaller DL data allocations. This scenario can be set in correlation with the balanced data rate (BDR) of modem 30. Here it is assumed that each slot is transmitting slightly more data than can be handled by primary buffer 38. Blocks 76 need to be stored on extended buffer 40 and post processed as they are beyond balanced data rate BDR.

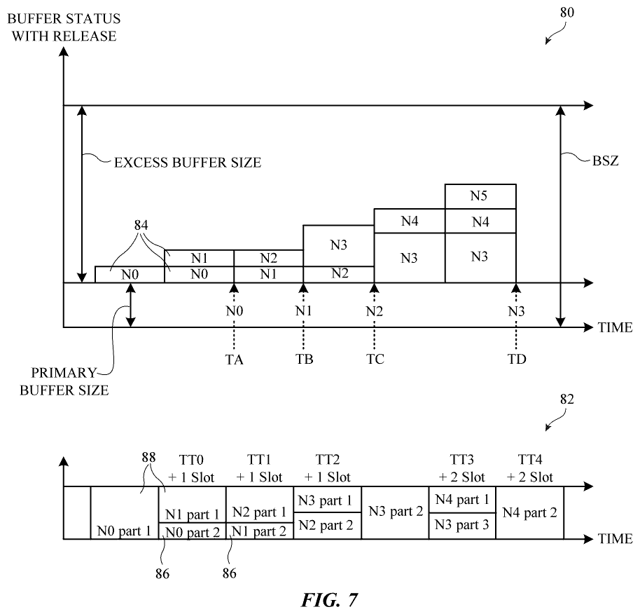

FIG. 7 shows how slots of DL data may be stored on buffers 38 and 40 and processed over time in this example. Plot 80 illustrates the storage of slots of DL data in primary buffer 38 (e.g., up to the primary buffer size) and in extended buffer 40 (e.g., from the primary buffer size to buffer size BSZ). Plot 82 illustrates the processing of DL data stored on buffers 38 and 40.

As shown in FIG. 7, the balanced data rate BDR of the DL data of slot 0 (e.g., a first portion of the resource elements NO in slot 0) is received and stored in primary buffer 38 (e.g., during a first time period or TTI0). The excessive portion of the resource elements in slot 0 (e.g., a second portion of the resource elements NO exceeding the capacity of primary buffer 38 due to the DL data rate exceeding the balanced data rate BDR) is stored in extended buffer 40 (see blocks 84). Processing circuitry 42 processes and clears (deallocates) the first portion of resource elements NO from slot 0 (“NO part 1”) from primary buffer 38 during the first time period (see, e.g., blocks 88).

During a second time period (e.g., the subsequent TTI1), processing circuitry 42 processes and clears (deallocates) the remainder of resource elements NO from slot 0 (“NO part 2”) from extended buffer 40 (see, e.g., blocks 86), such that slot 0 of DL data (e.g., resource elements NO) has been fully processed and cleared from the buffers by time TA. This causes the complete processing and clearing of slot 0 of DL data (resource elements NO) to be delayed by TTI0+1 slot relative to online processing only. During the second time period, the balanced data rate BDR of the DL data of slot 1 (e.g., a first portion of the resource elements N1 in slot 1) is received and stored in primary buffer 38. The excessive portion of the resource elements in slot 1 (e.g., a second portion of the resource elements N1 exceeding the capacity of primary buffer 38 due to the DL data rate exceeding the balanced data rate BDR) is stored in extended buffer 40 (see blocks 84). Processing circuitry 42 processes and clears (deallocates) the first portion of resource elements N1 from slot 1 (“N1 part 1”) from primary buffer 38 during the second time period (see, e.g., blocks 88).

During a third time period (e.g., the subsequent TTI2), processing circuitry 42 processes and clears (deallocates) the remainder of resource elements N1 from slot 1 (“N1 part 2”) from extended buffer 40 (see, e.g., blocks 86), such that slot 1 of DL data (e.g., resource elements N1) have been fully processed and cleared from the buffers by time TB. This causes the complete processing and clearing of slot 1 of DL data (resource elements N1) to be delayed by TTI1+1 slot relative to online processing only. Note that each TTI needs to be fully processed until processing the next one in time can begin. This procedure continues every slot (e.g., such that resource elements N2 for slot 2 are fully processed by a delayed time TC, resource elements N3 for slot 3 are fully processed by delayed time TD, etc.).

In the event that the DL data rate exceeds balanced data rate BDR for an extended period of time, extended buffer 40 will become rapidly filled or exceed. In this case, modem 30 may stop receiving new DL data until the extended buffer is processed and cleared (e.g., at operation 66 of FIG. 5). As can be seen in FIG. 7, the processing delay for each slot slowly increases when the data rate exceeds balanced data rate BDR. The maximum possible delay for a particular set of parameters can be estimated (e.g., by UE device 10 and/or the network) as follows: (1) in a first step, modem 30 is triggered with the defined peak data rate PDR until extended buffer 40 is full in slot nₘₐₓ, and (2) at this point in time, DL data transmission is stopped and the number of slots delayₘₐₓ until the extended buffer is empty is calculated (e.g., until the DL data received in last slot nₘₐₓ is processed). The above maximum delay can be calculated using the following parameters: buffer size BSZ in units of RE, balanced data rate BDR in units of RE/ms, and peak data rate PDR in units of RE/ms.

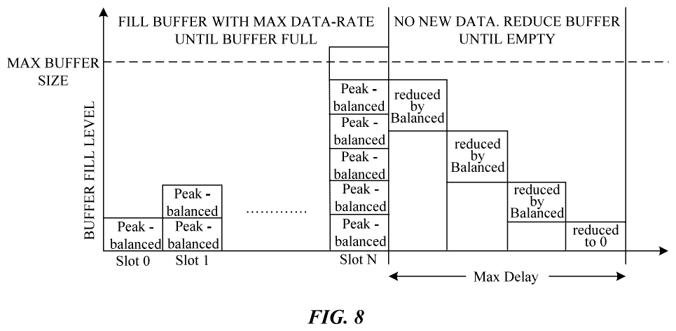

The buffer fill level at the end of slot n is given by buffer(n) which, starting with n=0, is calculated by the equation buffer(n)=Δ*(n+1), where Δ=PDR−BDR. Using a maximum buffer size equal to buffer size BSZ, the maximum slot nₘₐₓ with no buffer overrun (e.g., when sending at peak data rate) is calculated as buffer(n)=Δ*(n+1)<BSZ, which gives (n+1)<BSZ/A, which gives n<BSZ/Δ−1, which gives nₘₐₓ=Floor (BSZ/Δ−1). For the slot nₘₐₓ, the processing delay in number of slots (when transmission is stopped at nₘₐₓ so as not to cause a buffer overrun) can be calculated by dividing by balanced data rate BDR, or delay(nₘₐₓ)=Ceil(Δ*(nₘₐₓ+1)/BDR). FIG. 8 shows a graphical representation of this calculation

In the following a set of parameters are discussed and the implications especially for the maximum processing delay is shown. For this comparison the reference is the peak data rate PDR and a variable peakRE is defined as PDR*(unit time). The balanced data rate BDR as well as the buffer size BSZ are set relative to this quantity. In a first assumption, balanced data rate BDR is set to 50% of peak data rate PDR and up to four slots at peak data rate PDR can be handled by modem 30. The time unit used throughout this example is 1 ms. In other words, BDR=0.5*PDR and BSZ=peakRE*4. As such, the maximum delay delayₘₐₓ can be calculated as Δ=0.5*peakRE, where nₘₐₓ=Floor((4*peakRE)/(0.5*peakRE)−1)=7, and thus delay (nₘₐₓ)=Ceil(0.5*peakRE*(7+1)/(0.5*peakRE))=Ceil(8)=8. This is already a significant processing delay of 8 slots, which is assumed to require additional hybrid automatic repeat request (HARQ) process instances and associated memory. When reducing from 4 to 2 slot peak data rate storage size, the delay is reduced to 5 slots.

In an evaluation of modem data rates covering all real life cases in an acceptable manner, a 20% ratio compared to the peak data rate would be sufficient. In this example, using similar calculations to above but where BDR=PDR*0.2, delay (nₘₐₓ)=Ceil(20)=20. So, for this set of parameters, a delay of 20 slots for a 4 slot peak data rate storage is accumulated with only 4 slots. This delay is assumed to be much too high to still allow a reasonable amount of HARQ instances and round trip time. As such, also here a reduction to a buffer duration of 2 slots peak data rate is assumed realistic, still leading to maximum delays of approximately 10 slots. When taking

When performing a closer examination at this basic variation, to keep the maximum delay around 10 slots with the given parameters the buffer size should not exceed 2 peak data-rate slots. This also means that, when using peak data rates in DL, the associated buffer will be filled within 3-5 slots and the network needs to throttle afterwards. Still, this approach allows the network to schedule freely within these limits. Assuming that not all available NW resources are scheduled to a single UE, the filling of the buffer is typically much slower and the processing delay is much smaller.

Consider an example in which three symbols are stored with a resolution of 12 bit for I/Q. If up to 6.4 Mbit are allocated, scaling this to a complete slot (e.g., 14 symbols) leads to 6.4/3*14=30 Mbit for the storage of the time domain samples. Assuming a storage depth of 2 slots, this accumulates to 60 Mbit or around 7.5 MB. Using this storage size would allow to run a full offline processing starting with the TD (FFT) processing. However, as described above, only the PDSCH handling is assumed to be split over several slots the PDCCH decoding and handling is still performed in real-time. This however would require performing at least the time domain (TD) processing for the PDCCH symbols. So as not to further complicate the design and to reduce the overall storage requirements, it is assumed that the samples are stored after the time-domain processing. Compared to the pre-FFT TD samples the frequency domain samples can be reduced by the cyclic prefix (CP) duration (e.g., CP is assumed to account for 7% of the TD sample) as well as the really used RE in the frequency domain (approximately only 80% of the FFT size contains information). This leads to a reduction of the 60 Mbit to 60 Mbit*0.92 (CP)*0.8 (used RE)=44.16 Mbit=5.5 Mbyte for two complete slots.

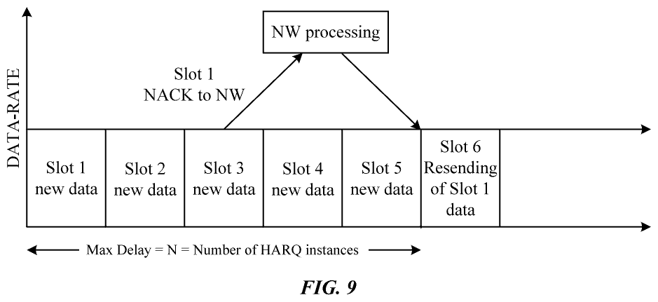

The current assumption is that the HARQ buffer size needs to be increased to handle the additional delay introduced by the peak data rate. The overall Demodulation and Decoding (DMDC) and additional HARQ buffer size can be split into three portions. A HARQ/DMDC buffer for constant balanced data-rate, an additional HARQ for offline processing delay, and additional HARQ buffers for peak buffer. The HARQ/DMDC buffer for constant balanced data rate is the data-rate the modem processing and the initial HARQ is designed for. A certain delay between reception of the DL block, sending of the corresponding UL ACK/NACK, and evaluation by the NW and resending of the TB is assumed (e.g. N slots). This is illustrated in FIG. 9. The HARQ process depth is then tailored to allow the NW to use the air interface for new data for N slots without having to wait for an ACK/NACK by the UE. The associated HARQ memory size can be scaled down to the targeted balanced data-rate.

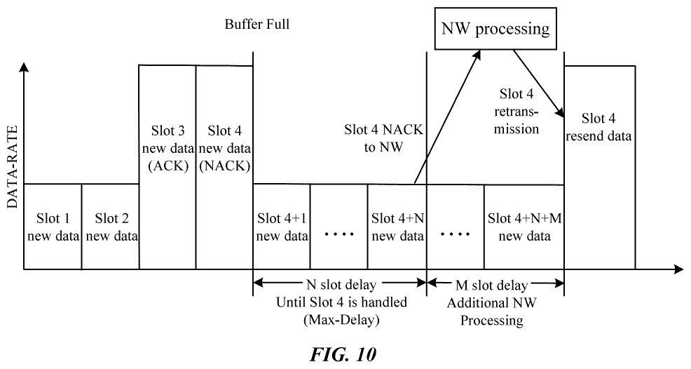

With additional HARQ for offline processing delay, the offline processing of data rates beyond the balanced data rate will cause an additional delay for the slot/transport block handling. This will cause a delay in the ACK/NACK transmission and thus to still enable constant new data-traffic from the NW the number of HARQ instances may need to be increased. The worst case use-case to estimate this scenario can be described as follows and is illustrated in FIG. 10. The NW has used the peak-data-rate in the previous slots (3 and 4 in the example of FIG. 10) until the allocated extended buffer is full. In the following slots, only the balanced data rate can be sent (so as not to exceed the maximum buffer size) until the previous peak data rate slots are processed. Processing of the balanced data rate slots is delayed by N slots (e.g., the time required to handle the last peak data-rate slot, or slot 4 in this example). N=delayₘₐₓ can be calculated as described above. Furthermore, the reaction time of M slots from the NW to receive the ACK/NACK and issue a retransmission needs to be taken into account. As such, the overall number of HARQ instances (sized for balanced data rate) may be increased by the maximum decoding delay N plus the NW reaction time M, where M is assumed to be 2 slots. The additional HARQ for the processing delay can be calculated as 3.15 Mbyte for a 50% balanced vs. peak data rate (e.g., where M=2, N=5, and a 2 peak slots buffer size), whereas a ratio of 20% leads to 1.8 Mbyte (e.g., where M=2, N=8, and a 2 peak slots buffer size).

The additional HARQ buffers for peak buffer: the previous paragraph focuses on the access HARQ memory for the delayed balanced data-rate slots. This however is only one portion that may need to be covered. The other portion is addressing the additional soft bits for handling the peak slot retransmission. When the peak slot (slot 4 in the example) is handled, the NW might to decide to resend the block to the device 10. This would fit into the frequency domain (FD) buffer without any issues. However, the LLR output would need to be combined with the previously-received soft bits of the peak slot. To do this, the existing HARQ buffers may need to be increased to cover as many soft bits as can be derived from the maximum RE buffer size (BSZ). No further scaling with the number of HARQ instances is required as the NW is not able to maintain the peak data rate in these cases, but needs to drop to at least balanced data rate BDR or lower so as not to exceed the FD buffer. Assuming that the buffer max is specified as peakRE (per slot)*(number of slots), the additional memory can simply be calculated by taking the HARQ buffer size divided by the used number of HARQ instances and multiplying with the (number of slots) used for the bufferₘₐₓ dimensioning. Note that this is independent from the ratio between balanced and peak data-rate and yields a size of 1.8 Mbyte for a buffer depth of two slots.

The above considerations may now be used to calculate baseband area required for two cases of 50% and 20% balanced vs. peak data rate. The calculation includes the following steps and approximations: (1) baseline for the Physical layer as well as the overall baseband, (2) the DMDC cluster logic, cores and I/D memory is simply scaled down by the balanced vs. peak ratio, (3) DMDC LIMEM is scaled separately to account for the reduction due to the balanced data-rate as well as the extension due to the additional HARQ Memory, (4) additional memory for the RE storage (2 slots) is added, (5) TDP, UL and GALA cluster are not scaled at all, and (6) other portions of the BB like PCIe, CPS cores and others are not scaled at all. Under these assumptions, configuring modem 30 in this way allows for a reduction in physical layer size, logic, and memory for both 50% and 20% balanced vs peak data rate. The reduction of the overall physical layer area is significant and made possible by designing for the balanced data rate. This shrink is mainly due to the logic scaling, while the LIMEM memory is reduced less due to the additional HARQ and RE buffer required for the peak data-rate buffering. When calculating the overall baseband size, the balanced data rate effect is reduced as most of the non-physical layer portions like interfaces and cores are not scaled and thus the physical layer reduction plays a smaller role.

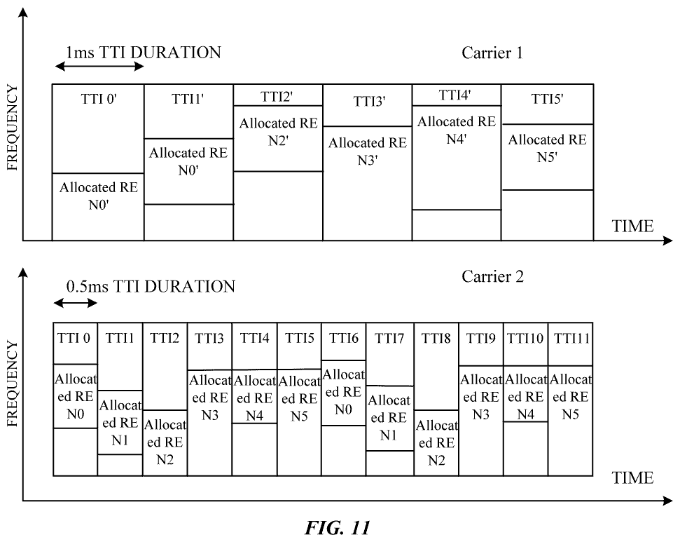

In the previous examples, an implementation with a single carrier is described for simplicity. This may be equivalently extended to configure modem 30 to handle several carriers with different TTI durations (e.g., due to different sub-carrier spacings (SCS) in OFDM-based systems). As an example, a two carrier scenario with two different TTI durations is shown in FIG. 11 (assuming time alignment between the two carriers). As shown in FIG. 11, the balanced RE rate is now split between both carriers. Any excess RE rate is split between the carriers with the ratio of the allocated RE. Checking the RE rate is performed on the shortest TTI duration. In this example, the smallest time unit is defined by the carrier having a TTI duration of 0.5 ms. Thus, the timing follows the TTI duration=0.5 ms time grid.

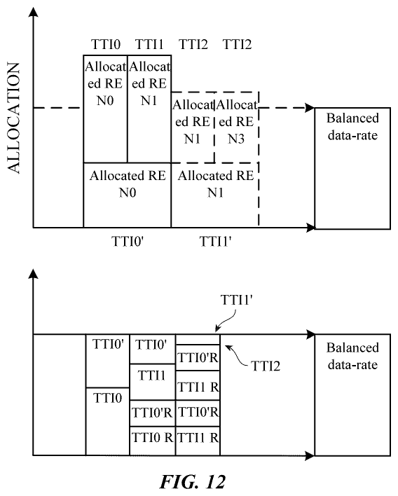

FIG. 12 illustrates additional details on how modem 30 may perform multi-carrier processing. For example, in TTI0, the balanced RE rate is checked against the sum of N0+N0′/2 RE elements. The RE from TTI0 and TTI0′ within the balanced data-rate are handled within this slot according to the ratio of the RE elements. Note that for the longer TTI only half of the elements are accounted for. In the next slot (TTI1), now at first the resource elements not covered in the previous slot are covered (i.e., TTI0 R and TTI0′ R). In case the peak data rate is much larger than the balanced data rate, this might cover several slots until the newly received TTIs can be handled. Baseline is that the RE's for the base-time grid (e.g. 0.5 ms) need to be handled completely before the processing of a new TTI can begin. In this case, the remaining parts can be handled and still some room for partial processing of the new slot may be available. “New slot” in this context means the TTI1 carrier having the TTI duration of 0.5 ms and the second half of the TTI0′ carrier with the TTI duration 1 of ms. In the following slot (TTI2) a similar handling is performed. Here, additional remaining data is accumulated and only very little room is left for processing of new data.

The above described approach can be extended to several carriers and even more different sub-carrier spacings. Baseline is that the RE's received in a basic time-unit (shortest TTI) need to be processed before the next slot is handled. For carrier having a different slot duration than the basic time-unit only the RE scaled down with the slot duration ratio is taken into account per basic time-unit. One problem however arises with this approach when different subcarrier spacings are used between the carriers. The delay for the carriers with longer slot duration than the basic time-unit (e.g., the shortest slot duration), can only be calculated when the last basic-time unit, contained in the longer slot duration is received. Only then can the accumulated RE and thus the time-delay for handling this slot be known. The delay is still deterministic but can only be calculated one slot later, compared to the handling with all equal sub-carrier spacings. Because the NW has complete DL scheduling under control this can be handled—the associated UL resource may just be planned one slot later. Note that the above scheme may require splitting all carriers between several slots when data beyond the balanced data rate is sent, although a complete handling of a subset of carriers would be possible without splitting. This causes some additional complexity in the FW and HW scheduling, but ensures that all carriers irrespective of the sub-carrier spacing and RE allocation are handled equally and no additional delay, beyond the estimated one, needs to be accounted for.

In the foregoing, all carriers are handled equally (e.g., when RE rates beyond the balanced data-rate are used, all carriers are delayed). In some scenarios it might be beneficial to prefer certain carriers (e.g., a primary cell (PCell) carrier) and always allow nominal 3GPP N1 and N2 values irrespective of these. To simplify handling, this capability may be bound to a single carrier. This means that the modem needs to be able to handle the full data rate for this carrier irrespective of the activity of the other carriers. The balanced and peak RE rate (DL data rate) may then only apply to the remaining carriers or include the guaranteed carrier. In the former case and in the case the guaranteed carrier is using the maximum data-rate, the remaining resources can be used to further increase the balanced RE rate that can be handled. Generally, the guaranteed Carrier bitrate increases the overall modem capability by extending the balanced RE rate by the guaranteed bit-rate, thus increasing the modem area and power consumption.

A guaranteed bit-rate may be also defined across carriers (e.g., to give the network scheduling flexibility), or may be defined within a single carrier (e.g., as a subset of the capabilities). This guaranteed bit-rate would be smaller than the balanced and peak rate and could be used to ensure that high priority data like of voice or video calls is processed with priority, for example. The network may indicate in a header or control information field that a certain data packet on a certain carrier is containing priority data, which is considered for the guaranteed bit-rate. In this case, modem 30 may adapt its processing schedule such that this prioritized data packet is guaranteed to be processed in the current TTI and potentially some other data, which was supposed to be processed in this TTI, is shifted to the extended buffer, if the processing capabilities (e.g., the balanced bit-rate) for this TTI would be exceeded. As the network is aware of the capabilities of the modem (balanced data rate, buffer sizes) and all data packets and which of these are prioritized, the network still knows exactly what data packet is processed when in the modem and can adjust its scheduling accordingly.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

The methods and operations described above in connection with FIGS. 1-12 may be performed using software, firmware, and/or hardware (e.g., dedicated circuitry or hardware). Software code for performing these operations may be stored on non-transitory computer readable storage media (e.g., tangible computer readable storage media) stored on one or more of the components of communications system 8. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of communications system 8. The processing circuitry may include microprocessors, central processing units (CPUs), application-specific integrated circuits with processing circuitry, or other processing circuitry.

As described above, one aspect of the present technology is the gathering and use of information such as user input, application data, and/or sensor information. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, eyeglasses prescription, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. A method of operating an electronic device to communicate with a wireless network, the method comprising:
transmitting, using a transmitter, a signal to the wireless network that identifies a balanced data rate of a modem on the electronic device, the balanced data rate being lower than a peak data rate of the modem; and
receiving, using the modem, downlink (DL) data transmitted by the wireless network according to a communications schedule, the communications schedule being generated by the wireless network based on the balanced data rate of the modem.

2. The method of claim 1, wherein the signal further identifies the peak data rate of the modem.

3. The method of claim 2, wherein the signal further identifies a guaranteed bit rate of the electronic device.

4. The method of claim 2, wherein the signal further identifies a buffer size of the modem.

5. The method of claim 1, wherein the signal further identifies a buffer size of the modem.

6. The method of claim 5, wherein the buffer size includes a number of resource elements storable in a buffer on the modem.

7. The method of claim 1, wherein the signal comprises a radio resource control (RRC) signal.

8. The method of claim 1, wherein receiving the DL data comprises:
receiving a first slot of the DL data at a first data rate less than or equal to the balanced data rate; and
receiving a second slot of the DL data at a second data rate greater than the balanced data rate.

9. The method of claim 8, further comprising:
storing, at a first portion of buffer circuitry on the modem, the first slot of the DL data;
clearing, using one or more processors, the first slot of the DL data from the first portion of the buffer circuitry;
storing, at the first portion of the buffer circuitry, a portion of the second slot of the DL data after the one or more processors has cleared the first slot of the DL data from the first portion of the buffer circuitry; and
storing, at a second portion of the buffer circuitry, a remainder of the second slot of the DL data.

10. The method of claim 9, wherein the signal further identifies a cumulative size of the first portion and the second portion of the buffer circuitry.

11. The method of claim 9, wherein the DL data has a first transmission time interval (TTI) duration, the method further comprising:
receiving, using the modem, additional DL data transmitted by the wireless network according to the communications schedule, the additional DL data having a second TTI duration different from the first TTI duration and having a third data rate greater than the balanced data rate; and
storing, at the first portion and the second portion of the buffer circuitry, the additional DL data.

12. The method of claim 1, wherein the wireless network identifies priority data associated with the electronic device based on a specific carrier or header/control information used by the electronic device, the method further comprising processing, using one or more processors, the priority data prior to processing other data.

13. An electronic device comprising:
one or more antennas;
a modem communicatively coupled to the one or more antennas, wherein the modem has a first buffer and a second buffer and is configured to fill, during a transmission time interval (TTI), the first buffer prior to the second buffer; and
a transmitter communicatively coupled to the one or more antennas and configured to transmit, to a wireless base station using the one or more antennas, a signal identifying a size of the first buffer and the second buffer.

14. The electronic device of claim 13, wherein the signal further identifies a peak data rate of the modem.

15. The electronic device of claim 14, wherein the signal further identifies a reduced data rate of the modem that is lower than the peak data rate.

16. The electronic device of claim 13, wherein the signal further identifies a reduced data rate of the modem that is lower than a peak data rate of the modem, wherein the modem is configured to receive, from the wireless base station during the TTI, downlink data at a data rate that exceeds the reduced data rate, the modem being configured to store a portion of the downlink data in the first buffer and a remainder of the downlink data in the second buffer, and the electronic device further comprising:
one or more processors configured to
process and clear the portion of the downlink data in the first buffer during the TTI, and
process and clear the remainder of the downlink data in the second buffer during an additional TTI subsequent to the TTI.

17. A method of operating an electronic device, the method comprising:
receiving, using a modem, a first slot of wireless data from a wireless base station during a first transmission time interval (TTI);
storing, at buffer circuitry on the modem, the first slot of wireless data received during the first TTI;
processing and clearing, using one or more processors during the first TTI, a portion of the first slot of wireless data stored at the buffer circuitry;
processing and clearing, using the one or more processors during a second TTI subsequent to the first TTI, a remainder of the first slot of wireless data stored at the buffer circuitry;
receiving, using the modem, a second slot of wireless data from the wireless base station during the second TTI; and
storing, at the buffer circuitry, the second slot of wireless data received during the second TTI.

18. The method of claim 17, further comprising:
processing and clearing, using one or more processors during the second TTI, a portion of the second slot of wireless data stored at the buffer circuitry;
processing and clearing, using the one or more processors during a third TTI subsequent to the second TTI, a remainder of the second slot of wireless data stored at the buffer circuitry;
receiving, using the modem, a third slot of wireless data from the wireless base station during the third TTI; and
storing, at the buffer circuitry, the third slot of wireless data received during the third TTI.

19. The method of claim 17, wherein the second slot of wireless data is received at a different data rate than the first slot of wireless data.

20. The method of claim 17, further comprising:
transmitting, using the modem, a signal to the wireless base station, wherein the signal identifies a size of the buffer circuitry and a data rate of the modem that is less than a peak data rate of the modem.
